(19) United States
(12) Patent Application Publication
(10) Pub. No.: US 2013/0267121 A1
(43) Pub. Date: Oct. 10, 2013

(54) Electronic Connector

(71) Applicant: Ching-Jen Hsu, Dongguan City (CN)

(72) Inventor: Ching-Jen Hsu, Dongguan City (CN)

(21) Appl. No.: 13/439,223

(22) Filed: Apr. 4, 2012

(51) Int. Cl. H01R 13/46

(52) U.S. Cl. 439/625

(57) ABSTRACT

An electronic connector comprising a metal enclosure, a rubber core, a rubber plug component and a cord. The rubber core and the rubber plug component are held inside the metal enclosure. The rear face of the metal enclosure is configured with a hole for the ingoing section of the cord to go through. The rubber core is configured with a raised bar along its front face and extending to the direction of the front end of the metal enclosure. The front end of the metal enclosure is formed with a limit stop to match the rubber core.

### BACKGROUND OF INVENTION

1. Field of the Invention

Present invention relates generally to the technical field of electronic connectors, and more particularly to a connector.

2. Description of Related Art

At present, connectors are widely used in the technical field of data transmission and electric power charging for electronic products.

The structure of a prior-art connector comprises a metal enclosure and a rubber core. The rubber core is fixed inside the cavity of the metal enclosure. On the socket end of the connector, the metal enclosure simply encloses the rubber core in its cavity. However, because of the longitudinal length of the rubber core, after repeated plugging between the connector and the mother socket connector, the front end of the rubber core will warp and deform upward, causing unsmooth plugging or even damage of the connector.

Moreover, because the metal enclosure is made of a die-cut thin metal plate with low structural strength, the abutment joint on the surface of the metal enclosure will be up-and-down dislocated or expanded after repeated plugging with the mother socket connector, causing unsmooth plugging of the connector, in more serious cases, even causing failure and reduced lifecycle of the connector.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The objective of the present invention is to avoid the shortcomings of the prior art and provide a connector with smooth plugging and longer life cycle.

For the above objective, the present invention of a connector includes a metal enclosure, a rubber core, a rubber plug component and a cord., The rubber core and the rubber plug component are held inside the metal enclosure. The rear face of the metal enclosure is configured with a hole for the ingoing section of the cord. to go through. The rubber core is configured with a raised bar along its front face and extending to the direction of the front end. of the metal enclosure. The front end of the metal enclosure is formed with a limit stop to match the rubber core.

Of which, said raised bar is a configuration extending from the upper part of the front face of the rubber core.

Of which, the outer side of the raised bar is to be aligned with the outer side of the limit stop.

Of which, the inner side of the limit stop is configured with a projection, and the front face of the rubber core is configured with a socket to match the projection.

Of which, the projection is configured on the center of the inner side of the limit stop.

Of which, the thickness of the limit stop is ½˜¾ of the thickness of the rubber core.

Of which, said metal enclosure is a zinc alloy integral metal enclosure.

Of which, said metal enclosure includes a front enclosure and a. rear enclosure, and the front enclosure is connected with the rear enclosure through plugging.

The present invention of a connector includes a metal enclosure, a rubber core, a rubber plug component, and a cord. The rubber core and the rubber plug component are held inside the metal enclosure. The rear face of the metal enclosure is configured with a hole for the ingoing section of the cord to go through. The rubber core is configured with a raised bar along its front face and extending to the direction of the front end of the metal enclosure. The front end of the metal enclosure is formed with a limit stop to match the rubber core. Comparing to the prior art, as the present utility model is formed with a limit stop on the front end of the metal enclosure, and the thickness of the limit stop can block most of the front face of the rubber core, the contact area of the front face of the rubber core during plugging is reduced, and the problem of upward warping and deformation of the front face of the rubber core and consequent unsmooth plugging of the connector in the prior art can be avoided. The present utility model can provide smooth plugging and longer lifecycle.

### BRIEF DESCRIPTION OF THE DRAWINGS

The present invention is described below in further details with the accompaniment of the attached drawings:

FIG. 1 is a structural representation of the present invention of an electrical connector.

FIG. 2 is an exploded view of the structure of the present invention of an electrical connector.

FIG. 3 is a structural representation of the rubber core of the present invention of an electrical connector.

FIG. 4 is a front view of the structure of the rubber core of the present invention of an electrical connector.

FIG. 5 is a side view of the structure of the rubber core of the present invention of an electrical connector.

### DETAILED DESCRIPTION OF THE INVENTION

Below are detailed descriptions of the present invention with the following accompanied embodiments.

### Embodiment 1

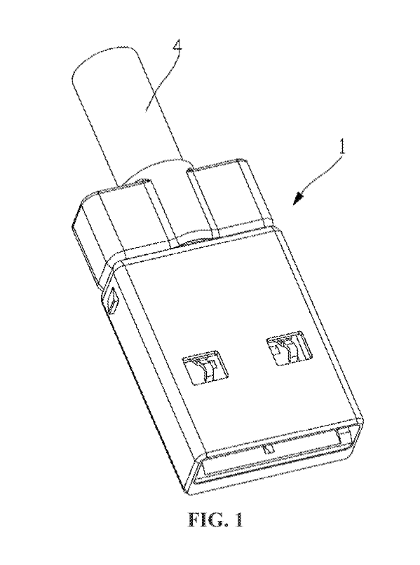

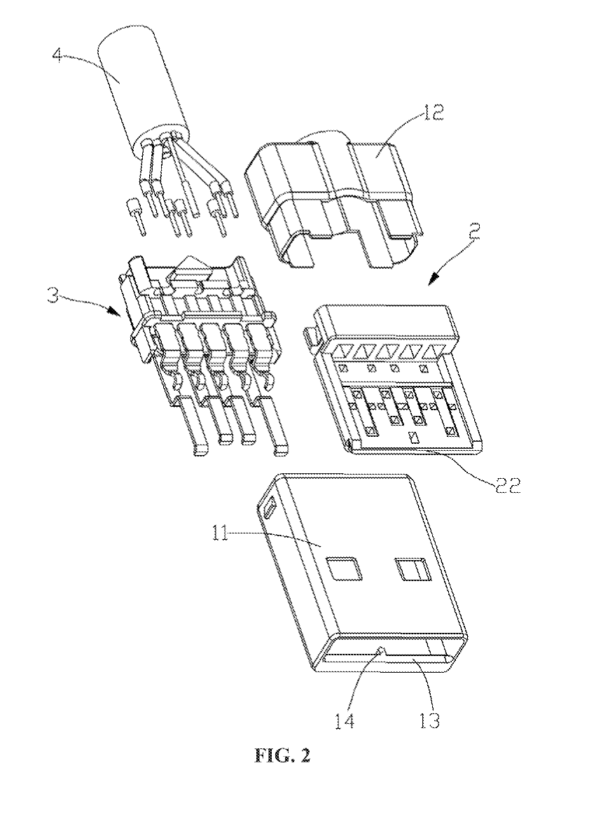

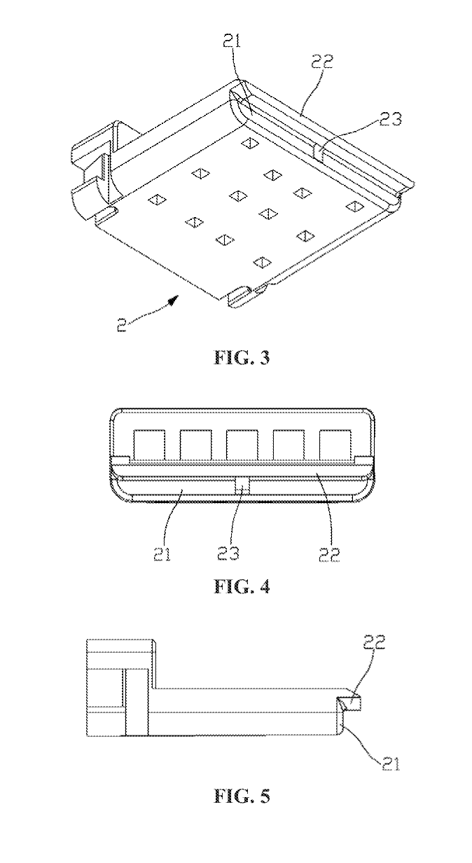

The detailed. implementation of the present invention of an electrical connector is depicted in FIG. 1 to FIG. 5. The connector comprises a metal enclosure 1, a rubber core 2, a rubber plug component 3 and a cord 4. Said rubber core 2 and said rubber plug component 3 are held inside the metal enclosure 1; the rear face of the metal enclosure 1 is configured with a hole; the ingoing end of the cord 4 goes through the hole, wherein, said rubber core 2 is configured with a raised bar 22 along its front face 21 and extending to the direction of the front end of the metal enclosure 1. The front end of the metal enclosure 1 is formed with a limit stop 13 to match the rubber core 2.

Comparing to the prior art, as the front end of the metal enclosure 1 in the present invention is formed with a limit stop 13, and the thickness of the limit stop 13 can block most of the front face 21 of the rubber core 2, the contact area of the front face 21 of the rubber core 2 during plugging is reduced, and the problem of upward warping and deformation of the front face 21 of the rubber core 2 and consequent unsmooth plugging of the connector in the prior art can be avoided. The present invention can provide smooth plugging and longer lifecycle.

Particularly, said raised bar 22 is a configuration extending from the upper part of the front face 21 of the rubber core 2.

Particularly, the outer side of the raised bar 22 is configured to be aligned with the outer side of the limit stop 13.

Particularly, the inner side of the limit stop 13 is configured with a projection 14, and the front face 21 of the rubber core 2 is configured with a socket 23 to match the projection 14.

Particularly, the projection 14 is configured on the center of the inner side of the limit stop 13.

Particularly, the metal enclosure 1 is an enclosure integrally formed with zinc alloy. Such an enclosure can avoid problems of loose connection between prior-art enclosures with too much gap in the middle, and meanwhile can provide better sealing and electromagnetic shielding. Also, it is low cost and easy to assemble.

Particularly, said metal enclosure 1 includes a front enclosure 11 and a rear enclosure 12. Said front enclosure 11 is connected with said rear enclosure 12 through plugging.

### Embodiment 2

The main technical scheme of the Embodiment 2 of the present invention of a connector is same as Embodiment 1. The characteristics not explained in this embodiment can be explained as Embodiment 1 and are not detailed here. This embodiment differs from Embodiment 1 in the following fact: the thickness of the limit stop 13 is ½˜¾ of the thickness of the rubber core 2.

Although the invention has been explained in relation to its preferred embodiment, it is to be understood that many other possible modifications and variations can be made without departing from the spirit and scope of the invention as hereinafter claimed.

1. An electronic connector, comprising a metal enclosure, a rubber core, a rubber plug component, and a cord; the rubber core and the rubber plug component are held inside the metal enclosure; the rear face of the metal enclosure is configured with a hole for the ingoing section of the cord to go through; it is characterized by the following fact: the rubber core is configured with a raised bar along its front face and extending to the direction of the front end of the metal enclosure; the front end of the metal enclosure is formed with a limit stop to match the rubber core.

2. The electronic connector as claimed in claim 1, wherein said raised bar is a configuration extending from the upper part of the front face of the rubber core.

3. The electronic connector as claimed in claim 2, wherein the outer side of the raised bar is configured to be aligned with the outer side of the limit stop.

4. The electronic connector as claimed in claim 1, wherein the inner side of the limit stop is configured with a projection, and the front face of the rubber core is configured with a socket to match the projection.

5. The electronic connector as claimed in claim 4, wherein the projection is configured on the center of the inner side of the limit stop.

6. The electronic connector as claimed in claim 1, wherein the thickness of the limit stop is ½˜¾ of the thickness of the rubber core.

7. The electronic connector as claimed in claim 1, wherein said metal enclosure is a zinc alloy integral metal enclosure.

8. The electronic connector as claimed in claim 1 or 7, said metal enclosure includes a front enclosure and a rear enclosure, and the front enclosure is connected with the rear enclosure through plugging.
